(19) United States
(12) Patent Application Publication
(10) Pub. No.: US 2007/0030148 A1
(43) Pub. Date: Feb. 8, 2007

(54) Motion-activated switch finder

(75) Inventors: Greg Gabriel, Los Altos, CA (US); Dave Hadden, Los Altos, CA (US); Eric Scott Micko, Rescue, CA (US); Eric Serdahl, Sunnyvale, CA (US)

Correspondence Address: ROGITZ & ASSOCIATES, 750 B STREET, SUITE 3120, SAN DIEGO, CA, 92101, US

(73) Assignee: GekkoTek, LLC

(21) Appl. No.: 11/198,797

(22) Filed: Aug. 4, 2005

(51) Int. Cl. G08B 21/00

(52) U.S. Cl. 340/540

(57) ABSTRACT

A small portable housing has a battery-powered LED and an adhesive layer that can be detachably stuck on a wall near a light switch. A PIR motion detector in the housing activates the LED when the room is dark and motion is sensed.

### I. FIELD OF THE INVENTION

The present invention relates generally to wall-mounted motion-activated switch finder lights.

### II. BACKGROUND OF THE INVENTION

Wall light switches with lighted operators, e.g., lighted toggles or rockers, that aid a person in locating the operators in the dark, have been introduced. For example, a neon discharge tube can be connected in series with a current limiting resistor, with the combination then being placed across the switch contact. When the switch is in the on position, power is shunted through the switch contact. When the switch is off, the neon tube is exposed to the ac line voltage. Because the neon requires only about a milliampere of current to glow, such a device advantageously works with even the smallest load connected in series with the light switch.

The present invention recognizes, however, that installing such a device, requiring, as it does, establishing connections to the ac power grid, is beyond many people and indeed preferably is done only by a trained electrician. Nonetheless, providing a way to facilitate locating a light switch in the dark without requiring the services of an electrician remains desirable. With this in mind, the present invention is provided.

### SUMMARY OF THE INVENTION

A system includes a portable housing, at least one battery in the housing, and at least one light emitting diode (LED) on the housing and electrically connectable to the battery. The system also includes an adhesive layer that can be detachably stuck on a wall of a room near, e.g., a light switch assembly that is electrically connected to an ac power grid. A motion detector is in the housing for providing a signal for activating the LED when the room is dark and motion is sensed. Accordingly, when the housing is positioned near the light switch assembly, the light switch assembly can be illuminated by the LED without connecting the system to the ac power grid.

In non-limiting embodiments the motion detector can be a passive infrared (PIR) detector. One or more mirrors may be juxtaposed with the PIR detector and oriented to reflect, onto the detector, infrared energy impinging at an angle of greater than forty five degrees relative to a direction of pointing of the detector.

In some implementations the housing can be shaped like an imaginary creature.

In particular embodiments a logic device is in the housing. The logic device receives the signal from the motion detector, and in response executes logic. The logic may include causing the LED to be energized only in the presence of a motion signal satisfying a predetermined motion threshold and an ambient light level in the room satisfying an ambient light enable threshold, such as when the room is dark. The logic may also include causing the LED to be de-energized regardless of the motion signal when the ambient light level in the room does not satisfy the ambient light enable threshold, such as when the room is illuminated. The LED may be energized gradually.

In another aspect, a method for facilitating locating a light switch in the dark includes disposing a motion detector in a housing and adhering the housing to a wall next to the light switch without connecting the housing or contents therein to the ac power grid. The method also includes energizing a light on the housing at least in part in response to signals from the motion detector such that a person can see the light switch.

In still another aspect, a system has a motion detector in a housing and generating a signal representative of motion. A wireless transmitter is also in the housing. A controlled device is distanced from the housing and is connected to a wireless receiver, such that the transmitter can send commands to the receiver to control the controlled device based on signals from the motion detector.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a front elevational view showing a switch finder in accordance with the present invention mounted near a wall-mounted light switch;

FIG. 2 is a side view of the switch finder shown in FIG. 1;

FIG. 3 is a schematic elevational view of non-limiting motion detector optics;

FIG. 4 is a side view of the optics shown in FIG. 3;

FIG. 5 is a block diagram of a non-limiting switch finder;

FIG. 6 is a perspective view of an alternate switch finder housing, configured as a three dimensional toy-like sculpture;

FIG. 7 is a flow chart of the logic that can be implemented by the switch finder;

FIG. 8 is a block diagram of an alternate motion detector-based system; and

FIGS. 9 and 10 are flow charts of logic that may be implemented by the system shown in FIG. 8.

### DETAILED DESCRIPTION OF THE PREFERRED EMBODIMENT

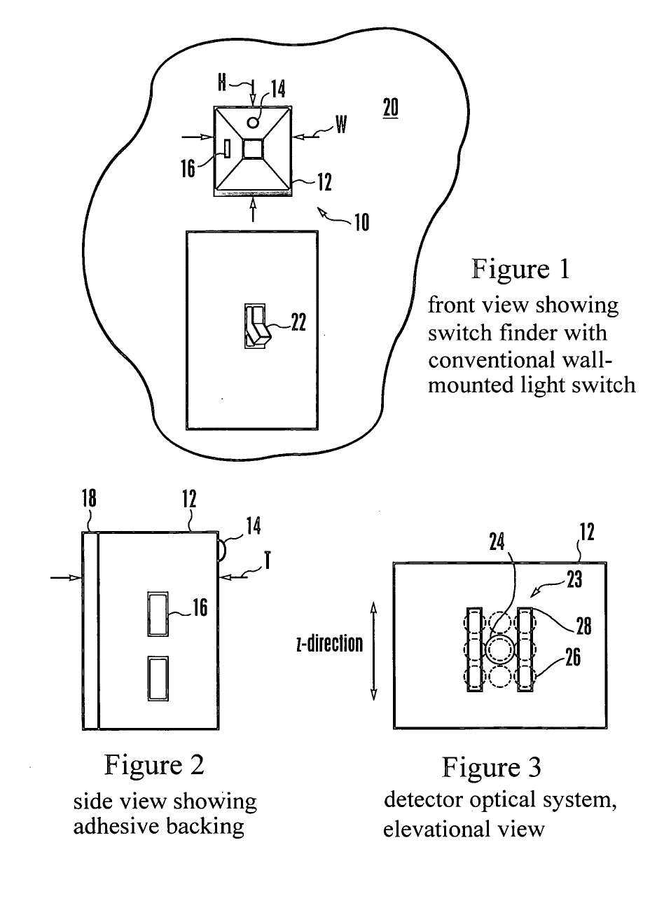

Referring initially to FIGS. 1 and 2, a system is shown, generally designated 10, which includes a portable, preferably plastic hollow housing 12 that holds the components shown in FIG. 5. The housing 12 holds at least one light 14 such as a light emitting diode (LED) 14, and the housing 12 may be transparent or translucent, in which case the LED 14 may be disposed within the housing, or the housing 12 may be opaque, in which case the LED 14 is mounted on an external surface of the housing. One or more user-manipulable controls 16 may also be mounted on the housing 12 for purposes to be shortly disclosed. An adhesive element such as a pad 18 (FIG. 2) preferably is included on the housing 12 so that the housing 12 may be easily stuck onto a wall 20 next to a light switch 22 that is connected to the ac power grid, so that when the LED 14 is energized in accordance with disclosure below, the light switch 22 is illuminated. Thus, the system 10 is a switch finder that is a simple solution for finding a light switch 22 in the dark. Once in place on the wall, the housing 12 subsequently can be removed by simply prying it from the wall, because the adhesive pad leaves no residue on the wall when removed and is reusable an indefinite number of times so the housing can be re-located as often as desired. The sticky surface is easily cleaned with a damp sponge whereupon its stickiness will be fully restored. In one embodiment, the adhesive material on the pad 18 may be urethane, silicone, PVC, or other material with high interfacial tack, and preferably not containing plasticizers or other additives that would leave a residue when removed.

In non-limiting embodiments the housing 12 may have a thickness “T” of less than seven-eighths of an inch, a width “W” of two and five-eighth inches, and a height “H” of two inches. These small dimensions, made possible by preferred optics and motion detectors set forth further below, render the system 10 unobtrusive.

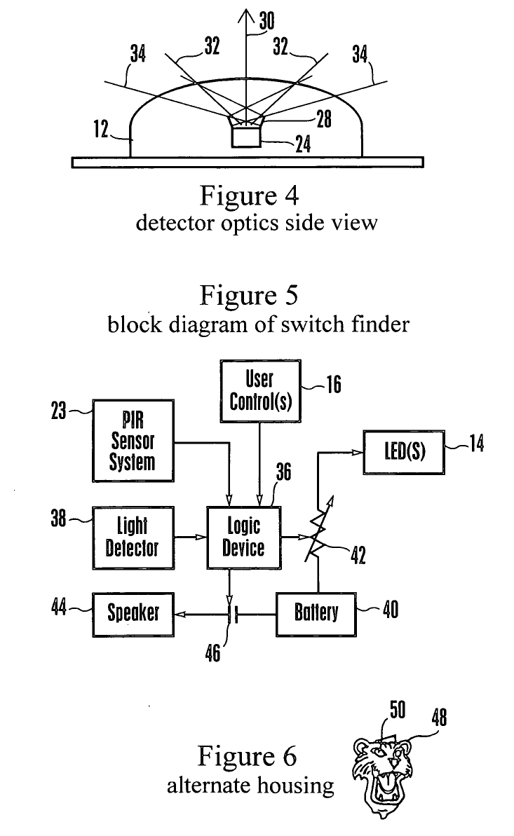

Details of the presently preferred motion detector system 23 with optics are shown in FIGS. 3 and 4. The motion detector system 23 includes a motion detector 24 that is disposed in the housing 12. The motion detector system 23 may be any one of the passive infrared (PIR) systems disclosed in the following published U.S. patent applications, all of which are incorporated herein by reference: 20050016283, 20040189149, 20040169145, 20040164647, 20040140430, which advantageously operate on less than fifteen microamperes and as low as ten microamperes. Since this power draw is so low, there is no need for an on-off switch in the system 10, thus adding to the simplicity and convenience of the system 10. If desired, the LED 14 can be controlled to blink when it is about time to replace the batteries.

Plural lenses 26 and mirrors 28 may be arranged as shown in the housing 12 to direct infrared energy toward the detector 24. Specifically, referring particularly to FIG. 4 and using the detector pointing direction 30 as reference, the lenses 26 refract, toward the detector, infrared energy that is impinging at angles of less than about forty five degrees from the pointing direction 30 as shown by lens field of view lines 32, while the mirrors 28 reflect, toward the detector, infrared energy that is at angles of more than about forty five degrees from the pointing direction 30 as shown by mirror field of view lines 34. To this end, the mirrors 28 flank the detector 24 and are oriented at oblique angles relative to the pointing direction 30 as shown, such that the mirror on the right in FIG. 4 reflects wide-angle infrared energy impinging from the left and the mirror on the left reflects wide-angle infrared energy impinging from the right. The combination of structure discussed above can detect motion up to about twenty five feet away from the detector 24, over an azimuthal range of about one hundred fifty degrees and an elevational range of about ±45 degrees from a plane parallel to the floor and normal to the wall.

FIG. 5 shows the non-limiting components of the system 10 within the housing 12. As shown, the motion detector system 23 is electrically connected to a logic device 36 to provide signals representing motion to the logic device 36. The logic device 36 may be a digital or analog circuit that executes the logic discussed below. It may also be a microprocessor that executes logic in the form of software. The logic may be embodied in hardware or firmware. In other words, the nature of the logic device is not limiting.

The signals from the detector system 23 may also be used as indications of the level of ambient light in the room, for purposes to be shortly disclosed. Or, a separate light detector 38 such as a photodiode or phototransistor can be disposed in the housing 12 and can send signals to the logic device 36 indicative of the level of ambient light in the room. The logic device 36 may also receive signals from the user controls 16 as shown.

One or more small primary dc batteries 40 can be disposed in the housing to power the components therein. The batteries may be, without limitation, type AAA alkaline batteries, and they may come packaged within the housing 12 with peel-off activation tags to prevent them from discharging until the tags are removed.

The battery or batteries 40 power the LED 14 as shown, with power from the battery 14 being selectively applied to the LED 14 under control of the logic device 36. In one non-limiting embodiment this may be accomplished by use of a variable resistor 42 in the line between the battery 40 and LED 14 and controlled as shown by the logic device 36. In such an implementation the resistance of the variable resistor is set high to mimic an open circuit when it is desired to turn the LED off; further operation of the variable resistor 42 is discussed further below.

Or, a simple relay contact or solid state switch may be disposed in the line between the battery 40 and components to be energized, such as the LED 14 or, in non-limiting embodiments, a small audio speaker 44 that is mounted on the housing. A contact 46 is controlled by the logic device 36 to selectively energize the speaker 44 using the battery 40.

Referring briefly to FIG. 6, the present housing may assume fanciful three dimensional shapes, such as that of a tiger head housing 48 having first and second LEDs 50 arranged as eyes of the tiger. That is, the housing may be shaped as an imaginary creature for reasons to be made clear shortly.

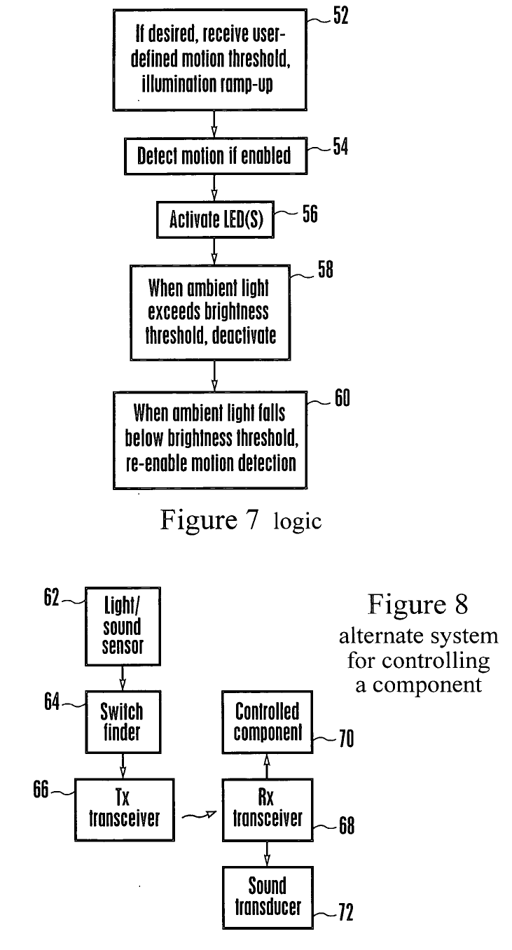

Regardless of the housing configuration, FIG. 7 illustrates logic that may be employed by the logic device 36. Commencing at block 52, when the system 10 incorporates user controls 16, such as, e.g., rollers or dials, the user control signals are received. By way of non-limiting example, the user may be permitted to establish, by means of the user controls 16, the rate at which the LED is illuminated. In other words, upon activation, the LED 14 may be “soft started”, i.e., energized with gradually increasing current by means of the variable resistor 42 under control of the logic device 36 over some interval of time rather than as a step function. Likewise, after a predetermined period of time, the LED 14 can be slowly turned off. The ramp-on, on, and ramp-off times can be independently adjusted over broad time ranges by means of the user controls 16. Yet again, the user controls 16 may enable a user to establish a motion threshold, below which the LED 14 will not be activated. In this way, the LED 14 will not be activated by slight movements, such as a person turning or moving in bed, but only by more deliberate motions, such as walking across a room. This non-limiting feature thus makes for a desirable travel night light since it has long battery life, is very small, light weight, and can be conveniently mounted and removed as often as desired from surfaces such as a wall or a door in a motel room. If desired, the variables discussed above can be preset during manufacture, and the user controls 16 omitted.

At block 54 the logic device 36 determines whether motion has been sensed, assuming that LED activation is enabled in accordance with disclosure below. As mentioned above, any signal from the detector system 23 may be interpreted by the logic device 36 as indicating motion, or only motion signals indicating a degree of motion above a threshold might result in a motion detection indication being interpreted by the logic device 36.

Proceeding to block 56 when a motion signal is interpreted by the logic device 36 to indicate motion, the LED(s) 14 are energized from the battery 40, either step-wise by means of a contact or gradually by means of the variable resistor 42 discussed above.

Block 58 indicates that the LED remains energized until a predetermined time period has elapsed since motion was detected or until the ambient light intensity in the room exceeds a predetermined threshold, as will happen if a person locates the switch 22 and turns on the room lights. As discussed above, the ambient light signal can be provided to the logic device 36 by the motion detector system 23 or by a separate light detector 38. As also mentioned, the LED 14 may be immediately de-energized or it may be gradually de-energized. At block 60, when the ambient light intensity in the room once again falls below the threshold, operation of the system 10 in energizing the LED 14 when motion is detected is once again enabled.

If desired, the logic device 36 may cause the LED 14 to flash a few times when motion is initially detected to attract the user's attention to the location of the switch before offering a continuous glow at a lower intensity.

In addition to the logic above, the logic device 36 may implement other operations depending on the embodiment. For instance, when the housing is shaped like a fanciful creature as shown in FIG. 6, the present system may perform the function of a night light in a child's room. When the room lights are turned off and the ambient light level is below the threshold intensity level in the room, the LEDs 50 (representing, for instance, an animal's eyes) are energized in response to motion and can be controlled to blink in a randomized sequence over some pre-defined period of time post-motion, and then slowly fade to off. The object of this night light concept is that the child will come to think of the night light as his “Knight Guardian” watching over him as evidenced by the animal's glowing, blinking eyes.

Further, if desired the brightness of the blinking LEDs 50 can be controlled to slowly decrease in intensity over several minutes until they are completely turned off so that the child has a smooth transition from light from the night light to total darkness. During the night, should the child wish to know that his Knight Guardian is on duty he has but to wave an arm in the room and the Knight Guardian's “eyes” will immediately glow and the repeat the light pattern described above. If desired, the speaker 44 shown in FIG. 5 can be activated by the logic device 36 in coordination with activation of the LEDs 50, or using any other sound activation paradigm.

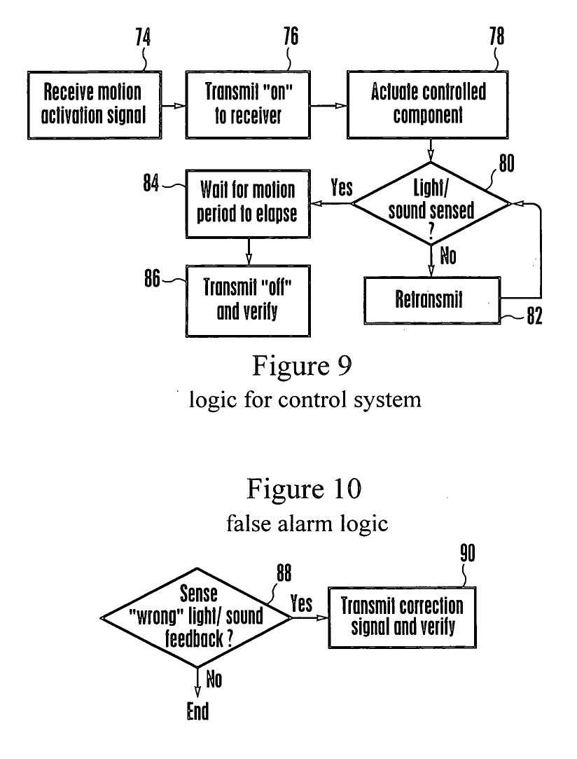

Now referring to FIGS. 8-10, an alternate system is shown incorporating the present motion detector system in a component control embodiment. As in the previous embodiments, an ambient light sensor 62 (which can be in combination with a sound sensor such as a microphone) can input ambient light (and/or sound) signals to a switch finder 64 that may be implemented by the components shown in FIG. 5. In turn, the logic device in the switch finder 64 can control a wireless transmitter 66, which may be a transceiver, to send wireless commands to a wireless receiver control module 68, which also may include a transceiver, at, e.g., an FCC-approved frequency of 433.92 MHz. The receiver control module 68 includes both the wireless receiver and control circuitry to actuate a controlled component 70, e.g., a light. When the controlled component is a light, the logic in FIGS. 9 and 10 may be implemented without the need for acoustic signals. When the component 70 is other than a light, e.g., when it is a fan, entertainment system, window covering, or other device, the receiver control module 68 can actuate a sound transducer 72 for detection of the resulting acoustic signal by the sound sensor of the transmitting system. In any case, the transmitter for sending the control signal may be an RF transmitter or IR transmitter.

The receiver control module 68 can either be powered by battery or from the ac electrical mains. Upon receipt of a prescribed command signal the receiver activates associated circuitry to power up the controlled component by connecting it to a battery or ac electrical mains using a relay or solid state switching means.

The logic of the logic device in the switch finder 64 commences at block 74 in FIG. 9, wherein when a motion signal is received, the logic moves to block 76 to transmit an “on” signal to the receiver. At block 78 the controlled component is actuated accordingly.

As recognized by the present invention, verification of proper command signal receipt and command execution is desirable. As also recognized herein, while bi-directional direct communication between the transmitter and receiver can be used, a simpler and less expensive method to prevent false activations or deactivations is desired.

Accordingly, the logic can move to decision diamond 80 to determine whether proper command execution has been undertaken by the receiver, using signals from the ambient light (and/or sound) sensor 62 shown in FIG. 8. More specifically, assuming that the controlled component is a light, immediately after transmitting the “on” command the logic device in the switch finder determines whether the ambient light in the room has increased markedly, as indicated by the signal from the light sensor. If the “on” signal is received by the receiver, and if the receiver activates the light, the light level detection circuitry in the switch finder generates a positive signal indicating that the remote light has been activated. The logic will thus flow from decision diamond 80 to block 84, to wait a predetermined time period after motion ceases if desired and then transmit an “off” signal to the receiver. On the other hand, if no light level change signal is detected at the transmitter within a predetermined (typically short) period after sending the “on” signal, the logic moves from decision diamond 80 to block 82 to retransmit another “on” signal. This can be repeated as often and as many times as desired.

This same protocol can be used to send a deactivation signal. In this case, the light level detection circuitry essentially generates an off signal verifying that the remote light has been deactivated.

It is thus to be understood that in non-limiting embodiments the transmitter can send an “on signal” and the receiver can verify it by returning a verification signal. If the transmitter does not receive verification, it can send another “on” signal and can continue this indefinitely. Or, the transmitter can generate an error signal such as a flashing LED if two or three or other number of “on” signals are not responded to. The same holds true for “off” signals—the transmitter can keep sending an “off” signal until it receives verification from the receiver, or it can generate an error signal after no response is received after a predetermined number of “off” signal transmissions.

In the event that the controlled component is something other than a light, the sound transducer 72 (possibly in the ultrasonic frequency range) can be substituted for the light source at the receiver. This sound transducer can transmit one frequency when an “on” signal is received and a different frequency if an “off” signal is received, with the sound sensor of the transmitter, preferably with narrow band pass filters at the two frequencies, detecting the confirmation signals. The logic then operates analogously to that shown in FIG. 9 for light feedback. In any case, an rf-based activation signal may be sent and a non-rf based acknowledgement signal returned. Equivalently, an IR-based activation signal may be sent and a non-IR based acknowledgement signal returned.

FIG. 10 illustrates the present invention's recognition that a false signal may cause the receiver to activate or deactivate a light. In such a case, the “wrong” ambient light level for the logical condition of the switch finder is received by the transmitter's light detector at decision diamond 88, and when this happens, the logic moves to block 90 to transmit a correction signal to the receiver as required to reconfigure the controlled component appropriately.

The above verification method also can be used with a simple manual switch closure (or opening) or with any of a multitude of inputs such as light or sound. For an added degree of reliability the verification signals can be encoded as a series of pulses of unique pattern.

While the particular MOTION-ACTIVATED SWITCH FINDER as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A system, comprising:
a portable housing;
at least one battery in the housing;
at least one light emitting diode (LED) on the housing and electrically connectable to the battery;
an adhesive layer that can be detachably stuck on a wall of a room near a light switch assembly electrically connected to an ac power grid; and
a motion detector in the housing, the motion detector providing a signal for activating the LED when the room is dark and motion is sensed such that when the housing is positioned near the light switch assembly, the light switch assembly is illuminated by the LED without connecting the system to the ac power grid.

2. The system of claim 1, wherein the motion detector is a passive infrared (PIR) detector.

3. The system of claim 2, wherein the housing is shaped like a creature.

4. The system of claim 2, comprising a logic device in the housing and receiving the signal from the motion detector, the logic device executing logic comprising:
causing the LED to be energized only in the presence of a motion signal satisfying a predetermined motion threshold and an ambient light level in the room satisfying an ambient light enable threshold; and
causing the LED to be de-energized regardless of the motion signal when the ambient light level in the room does not satisfy the ambient light enable threshold.

5. The system of claim 4, wherein the LED is energized gradually.

6. The system of claim 1, wherein the motion detector never consumes more than fifteen microamperes.

7. The system of claim 1, comprising:
a wireless transmitter in the housing; and
a controlled device distanced from the housing and connected to a wireless receiver, the transmitter sending commands to the receiver to control the controlled device at least in part based on signals from the motion detector.

8. A method for facilitating locating a light switch in the dark, the light switch being connected to an ac power grid, the method comprising:
disposing a motion detector in a housing;
adhering the housing to a wall next to the light switch without connecting the housing or contents therein to the ac power grid; and
energizing a light on the housing at least in part in response to signals from the motion detector such that a person can see the light switch.

9. The method of claim 8, wherein the light is an LED and the motion detector is a PIR detector system, both of which are connected to a battery in the housing.

10. The method of claim 8, wherein the housing is shaped like an imaginary creature.

11. The method of claim 9, comprising:
causing the LED to be energized only in the presence of a motion signal from the PIR detector satisfying a predetermined motion threshold and an ambient light level in the room satisfying an ambient light enable threshold; and
causing the LED to be de-energized regardless of the motion signal when the ambient light level in the room does not satisfy the ambient light enable threshold.

12. The method of claim 9, comprising energizing the LED gradually.

13. The method of claim 9, comprising controlling a controlled component based on signals from the motion detector.

14. A system, comprising:
a motion detector in a housing and generating a signal representative of motion;
a wireless transmitter in the housing;
a controlled device distanced from the housing and connected to a wireless receiver, the transmitter sending commands to the receiver to control the controlled device at least in part based on signals from the motion detector.

15. The system of claim 14, wherein the controlled device is a light electrically powered from an ac power grid.

16. The system of claim 15, wherein the motion detector is a PIR detector that consumes less than fifteen microamperes.

17. The system of claim 14, comprising a logic device in the housing and receiving signals from the motion detector, the logic device causing the transmitter to send an “on” signal to the receiver in response to a motion signal from the detector.

18. The system of claim 17, wherein the logic device causes the transmitter to retransmit the “on” signal if a signal representing ambient light above a threshold is not received by the logic device within a predetermined time period.

19. The system of claim 14, wherein the controlled device is selected from the group consisting of: fans, entertainment systems, window coverings.

20. The system of claim 19, comprising a logic device in the housing and receiving signals from the motion detector, the transmitter being an RF transmitter, the logic device causing the transmitter to send an “on” signal to the receiver in response to a motion signal from the detector and to resend the “on” signal if a non-RF based feedback signal is not received by the logic device within a predetermined period.
